(19) United States
(12) Patent Application Publication
(10) Pub. No.: US 2025/0112917 A1
(43) Pub. Date: Apr. 3, 2025

(54) ANONYMOUS DEVICE FINGERPRINTING FOR DEVICE VERIFICATION

(71) Applicant: Magic Labs, Inc., San Francisco, CA (US)

(72) Inventors: Michael FINN, Bend, OR (US); Joe BLACK, New York, NY (US); Wentao LIU, San Jose, CA (US); Fei-Yang JEN, New York, NY (US); Michael Berryhill, Waxhaw, NC (US)

(21) Appl. No.: 18/896,716

(22) Filed: Sep. 25, 2024

Related U.S. Application Data
(60) Provisional application No. 63/586,762, filed on Sep. 29, 2023.

(51) Int. Cl. H04L 9/40

(52) U.S. Cl. CPC H04L 63/0861

(57) ABSTRACT

Systems, methods, and computer readable media are described herein that use a user-agent-based non-extractable cryptographic keypair to generate a cryptographic proof containing a device fingerprint that an authentication system can use to subsequently identify and/or register a known device. Specifically, the systems disclosed herein may generate the device's “fingerprint” in an isolated and secured environment. Although the private key cannot be extracted from the isolated and secured environment, the authentication system can verify the truthfulness of the device's identity. This cryptographic “fingerprint,” in concert with a synchronous authentication system, has the ability to essentially eliminate authentication phishing. By ensuring that the cryptographic fingerprint of the device answering the synchronous authentication challenge has the same cryptographic fingerprint as the device that initiated the authentication request, the operation ensures the integrity of the authentication mechanism by verifying the legitimacy of the requesting device.

### CROSS REFERENCE TO RELATED APPLICATIONS

This application claims the benefit of U.S. Provisional Patent App. No. 63/586,762, filed Sep. 29, 2023, the disclosure of which is hereby incorporated by reference herein.

### TECHNICAL FIELD

This disclosure relates generally to systems, methods, and computer readable media to perform device verification operations. More particularly, the systems, methods, and computer readable media are configured to perform anonymous device fingerprinting for device verification.

### BACKGROUND

For as long as the Internet and email have been in existence, “phishing” has existed as a way of harming users and their interests. Typical authentication phishing attacks consist of an attacker first creating a “spoofed” web page that entices the victim to somehow enter their credentials, then storing those credentials for later use after the phishing campaign has completed, and, finally, using those stolen credentials to impersonate the user on the legitimate website-oftentimes taking illegitimate actions that are contrary to the user's own interests.

Synchronous authentication mechanisms may attempt to address phishing by eliminating user-known passwords, instead requiring that the credentials used to authenticate a device are system-created and securely shared immediately prior to use. This limits the “shelf-life” of stolen credentials and largely eliminates the “steal, store, and use later” phishing approach, as outlined above.

However, even with synchronous authentication, a user can still be tricked into entering their authentication data into an illegitimate site, and that site can then, i.e., synchronous with the victim's connection, attempt to login and impersonate the victim. To address this residual risk, some solutions require “registering” the device. However, previous “device registration” approaches have relied on device “metadata,” such as the device's IP address, MAC address, user agent strings, etc. However, there is an inherent risk with these approaches, since all of these data points can also be spoofed. Consequently, these approaches can be bypassed by an attacker by creating a spoofed set of metadata, which they can control to look identical to the legitimate device's metadata.

Thus, the subject matter of the present disclosure is directed to overcoming, or at least reducing the effects of, one or more of the problems set forth above. To address these and other issues, new techniques and system architectures are disclosed herein that can help to eliminate authentication phishing.

### BRIEF DESCRIPTION OF THE DRAWINGS

FIG. 1A is a block diagram illustrating an exemplary web browser-based device verification flow, according to one or more disclosed embodiments.

FIG. 1B is a block diagram illustrating an exemplary mobile device-based device verification flow, according to one or more disclosed embodiments.

FIG. 2 is a flowchart illustrating an exemplary method for performing the various operations described herein, according to one or more disclosed embodiments.

FIG. 3 is a block diagram illustrating a computer which could be used to execute the various operations described herein, according to one or more of disclosed embodiments.

### DETAILED DESCRIPTION

The following is a glossary of terms that may be used in this disclosure:

Proof—Cryptographic evidence that demonstrates possession of a private key.

User Agent—User-agent represents the single browser and/or device that an end-user uses to access a system.

Fingerprint—An identifier, derived from or containing a proof, which can be used to uniquely identify a device to a system. In some implementations, a fingerprint does not include the use of any actual device or hardware information (e.g., IMEI numbers for a phone, or the like).

Systems, methods, and computer readable media are described herein that are configured to use a user-agent-based non-extractable keypair to generate a cryptographic proof that can be used to subsequently identify and/or register a known device. Specifically, the systems disclosed herein may generate the device's “fingerprint” in an isolated and secured environment. Although the private key cannot be extracted from the isolated and secured environment, the authentication system can verify the truthfulness of the device's identity. This cryptographic “fingerprint,” in concert with a synchronous authentication system, has the ability to essentially eliminate authentication phishing.

By ensuring that the cryptographic fingerprint of the device that is answering the synchronous authentication challenge has the same cryptographic fingerprint as the device that initiated the authentication request, the anonymous device fingerprinting operation ensures the integrity of the authentication mechanism by verifying the legitimacy of the requesting device. In the event of a fingerprint mismatch (i.e., indicating that different devices were used across the authentication processes), a downstream authentication system can take additional actions to ensure security (e.g., either blocking the authentication entirely by enforcing same device verification and/or implementing a method to check the authenticity of the device and registering the cryptographic fingerprint as a known good device).

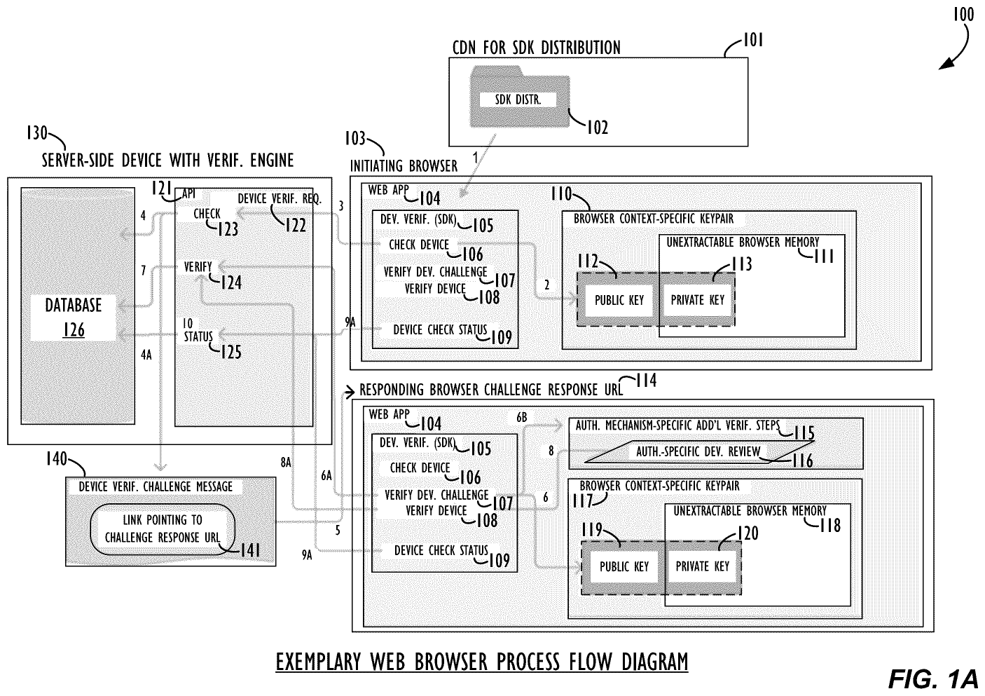

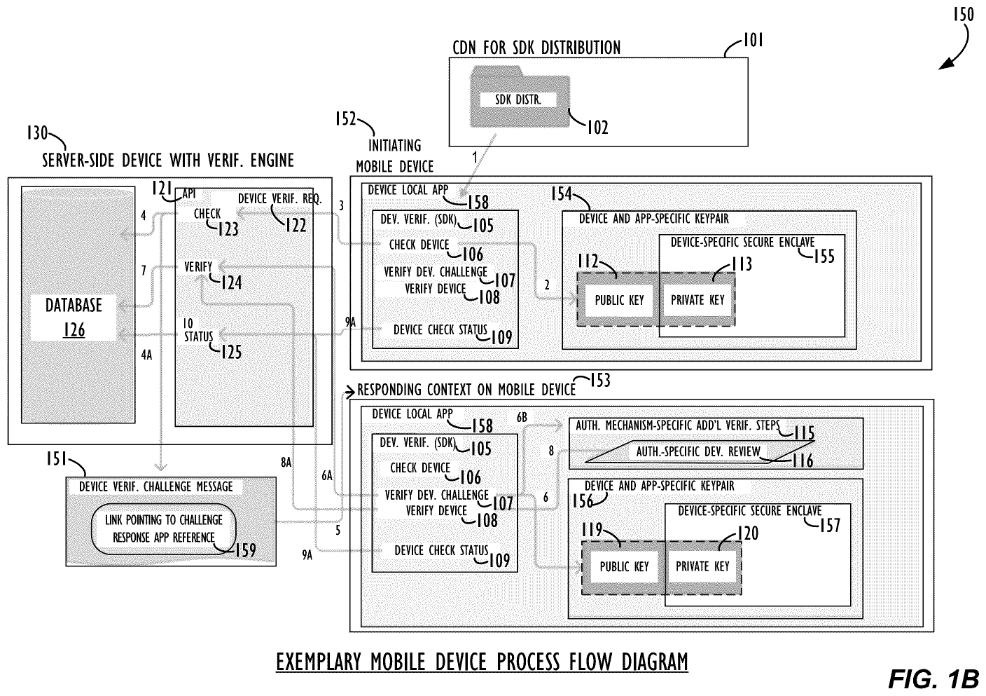

Turning now to FIG. 1A, a block diagram illustrating an exemplary web browser-based device verification flow 100 is shown, according to one or more disclosed embodiments.

A content distribution network (CDN) 101 configured for software development kit (SDK) distribution may comprise an SDK library 102 for distribution to client browsers/mobile devices. The SDK library 102 acts as a framework that provides an interface for the Web APP 104 to initiate or cause the execution of device fingerprinting operations on the client browsers/mobile devices. First, at Step 1, a web application (or “Web App”) 104 in an initiating browser 103 may pull (i.e., download) the SDK library 102 from CDN 101. Web App 104 may gather various information related to the user of the initiating browser 103 (e.g., email address, telephone number, etc.) to use as a secure context identifier. Web App 104 may further comprise a device verifier SDK 105 (e.g., the SDK library 102 previously downloaded from CDN 101), configured to perform various methods, such as: checking the device (106), verifying a device challenge (107), verifying the device (108), and/or running a device status check (109).

Next, at Step 2, the check device method 106 may use the SDK 105 to confirm the existence of the browser-based non-extractable context-specific keypair 110 of the initiating browser 103. The browser context-specific keypair 110 may contain both the public cryptography key 112 and the private cryptography key 113 for the initiating browser 103. Private cryptography key 113 is maintained in an unextractable portion of the browser memory 111, i.e., a portion of the memory that remains in a secure environment and cannot be sent outside of the browser. More particularly, in the web context, the notion of extractability is part of the webcrypto API standard (see, e.g., Subsection 6.2). In the mobile device context, as will be described below with reference to FIG. 1B, the unextractable values may be stored in a secure enclave. Although this disclosure generally describes the use of a private cryptography key 113 or private key, implementations described in the disclosure can also use other types of secure, random, or pseudorandom generated secret values and/or data.

According to some implementations, this process of performing the check device method 106 may first comprise initiating the webcrypto library, then verifying if there is already an existing webcrypto keypair (and, if not, creating a new webcrypto keypair). Once the existing (or newly-created) webcrypto keypair is obtained, the check device method 106 may then generate a cryptographic proof containing the details of the request signed by the webcrypto keypair. The signature of this proof can be used to verify and uniquely identify the originating keypair related to the proof.

Next, at Step 3, the check device method 106 may use an API call (or the like) to send a device verification request 122 to a server-side device 130 executing a device verification engine, i.e., in order to attempt to verify the initiating browser 103. According to some embodiments, the device verification request may comprise: a secure context identifier, a proof (i.e., generated from a cryptographic keypair), and an app identifier (e.g., in a multi-tenant environment, the app identifier may comprise an API key or some other identifier to uniquely identify the tenant). Although this disclosure generally references the use of a server-side device 130, other implementations could have the server-side device 130 be a system that includes one or more servers (e.g., a single sever or a cloud-based system).

At Step 4, the server-side device 130 may use a verification API 121 to perform a check operation 123 on the device verification request 122. According to some implementations, first, the cryptographic proof may be deserialized in order to derive the unique device fingerprint, e.g., by extracting a public key from a token header, etc. Next, the server-side device 130 may attempt to look up the fingerprint, e.g., in a local secure database 126. If the fingerprint is present and verified for secure context identifier and app identifier received as part of the device verification request 122, the API 121 may return a unique identifier for the fingerprint (e.g., a unique identifier that may be used to uniquely identify the proof that was submitted, and which may be used in a call to the device status check method 109). If, instead, the fingerprint is not present, the API 121 may write the new fingerprint to database 126, generate a device-specific nonce value, and set a current value of a device verification status to “FALSE” (or other value indicative of the fact that the device has not been successfully verified yet). For example, the nonce value can be any value that is known and signed by a server private key. The nonce value may later be used to ensure that the verify call (124) is legitimate. For this reason, the nonce value may also be used as a so-called “server security verifier.”

Next, at Step 4A, if the device is unverified, the API 121 may send a device verification challenge message 140 to the secure context identifier (e.g., the user's email address or telephone number, etc.) and return a unique identifier for the current fingerprint to the Web App 104. In some embodiments, the device verification challenge message 140 may comprise a link 141 pointing to a challenge response URL.

Next, at Step 5, the user may follow the link 141 in the device verification challenge message 140 and connect to the challenge response URL. (Note: In FIG. 1A, this process is shown as involving two separate browsers, i.e., initiating browser 103 and responding browser 114, to signify that, after a successful verification, the web browser context becomes a web browser context that has been verified to be associated with the secure context identifier provided.) Responding browser 114 may also comprise a browser context-specific keypair 117 (analogous to browser context-specific keypair 110 of the initiating browser 103). The browser context-specific keypair 117 contains both the public cryptography key 119 and the private cryptography key 120 for the responding browser context 114. Again, private cryptography key 120 is maintained in an unextractable portion of the browser memory 118. As may now be appreciated, in the event that the responding browser 114 is different from the initiating browser 103, e.g., in the event of a phishing attempt, the responding browser 114 (and the corresponding keys 117-120) would be different than those from the initiating browser 103 context. Thus, according to some implementations, by initially assuming that browsers 103 and 114 are different contexts, and then working through the cryptographic proofs to invalidate that assumption, the verification system is able to prove that they are, in fact, the same context.

When the challenge response URL is loaded at Step 6, the responding browser 114 may receive various information related to the challenge, such as: the device identifier, a device token containing the generated cryptographic proof, and/or a server security verifier (e.g., a nonce from the server signed with the server private key). The verify device challenge method 107 may then be called with this information upon page load. As part of verify device challenge method 107, a verification operation on the Web App 104 may: initiate the webcrypto library, verify if there is already an existing webcrypto keypair (and, if not, create a new webcrypto keypair), and then, once the existing (or newly-created) webcrypto keypair is obtained, the verify device challenge method 107 may then receive the device token containing the cryptographic signature and use the local webcrypto public key to attempt to verify the device fingerprint.

Next, at Step 6A, if the cryptographic signature is verified, the verify device challenge has succeeded, and the verify device challenge method 107 may use an API call (or the like) to send a verification notification (e.g., along with the device identifier, device token and a server security verifier) to the API 121, so that the device may be verified (124). In addition, the device challenge method 107 may “return” a value to the Web App 104 with a value of “TRUE” (or other value indicative of the fact that the device has been successfully verified).

If, instead, at Step 6B, the cryptographic signature is not verified, then the verify device challenge has failed, and the verify device challenge method 107 may “return” a value of “FALSE” (or other value indicative of the fact that the device has not been successfully verified yet) to the Web App 104, and indicating, optionally, that additional verification steps are required to be performed if it is still desired to verify the device.

At Step 7, the API 121 may proceed to look up the fingerprint for the received device identifier, e.g., in database 126, verify that the nonce values in the server security verifier matches the nonce value in the fingerprint record and, if so, finally mark the device/browser as being verified in database 126.

According to some embodiments, at Step 8, the device verification operation may include an additional optional authentication mechanism with additional device verification steps (115). For example, according to some such embodiments, when a downstream authentication mechanism (e.g., 115) receives a “FALSE” value at Step 6B, an authentication-specific device review process 116 may implement additional verification steps that, if satisfied, may permit the device to be verified/registered. For example, the downstream authentication mechanism 115 may call the verify device method 108, passing the device identifier, device token, and/or server security verifier as input parameters. Once successful, at Step 8A, the verify device method 108 may use an API call (or the like) to send a verification notification (e.g., along with the device identifier, device token and/or a server security verifier) to the verify endpoint (124) of the API 121. Additionally, the verify device method 108 may “return” a value to the Web App 104 with a value of “TRUE” (or other value indicative of the fact that the device has been successfully verified), so that the Web App 104 may know the device has been verified.

According to still other embodiments, at Step 9, once the device identifier has been received, the Web App 104 can optionally check on the device verification status at any time by calling the device status check method 109. Then at Step 10, the device status check operation 125 may comprise: looking up the device fingerprint (e.g., in database 126), and then, if the fingerprint is present and verified, returning a status indicating that the device is known, while, if the fingerprint is not present or is verified, returning a status indicating the device's current verification status (e.g., pending, unknown, other, etc.).

Referring next to FIG. 1B, a block diagram illustrating an exemplary mobile device-based device verification flow 150 is shown, according to one or more disclosed embodiments. Elements of the system and device verification flow illustrated in FIG. 1B (related to mobile device-based device verification) may be considered as behaving identically (or analogously) to the correspondingly numbered elements of FIG. 1A (related to web browser-based device verification), subject to the various mobile-device-specific components, will now be discussed in greater detail below.

Beginning with initiating mobile device 152 and the responding context 153 on the mobile device (i.e., representing the context of the mobile device once it has been verified), it may be seen that a primary distinction between FIG. 1A and FIG. 1B is that FIG. 1B involves mobile devices, which may be executing a mobile application or the like, i.e., rather than a web-based browser, as in the example of FIG. 1A. Similarly, the mobile device 152/153 utilizes a device and app-specific keypair 154/156, as opposed to the browser-specific keypairs 110/117 of FIG. 1A, as well as a device-specific secure enclave 155/157, as opposed to the unextractable browser memory portions 111/118 of FIG. 1A.

Additionally, the mobile device 152/153 may be executing an app 158 locally on the device to perform the device verification operations, as opposed to the browser Web App 104 of FIG. 1A.

Finally, the device verification challenge message 151 may comprise a link 159 pointing to a challenge application reference (i.e., as opposed to the device verification challenge message 140 that comprises a link 141 pointing to a challenge response URL).

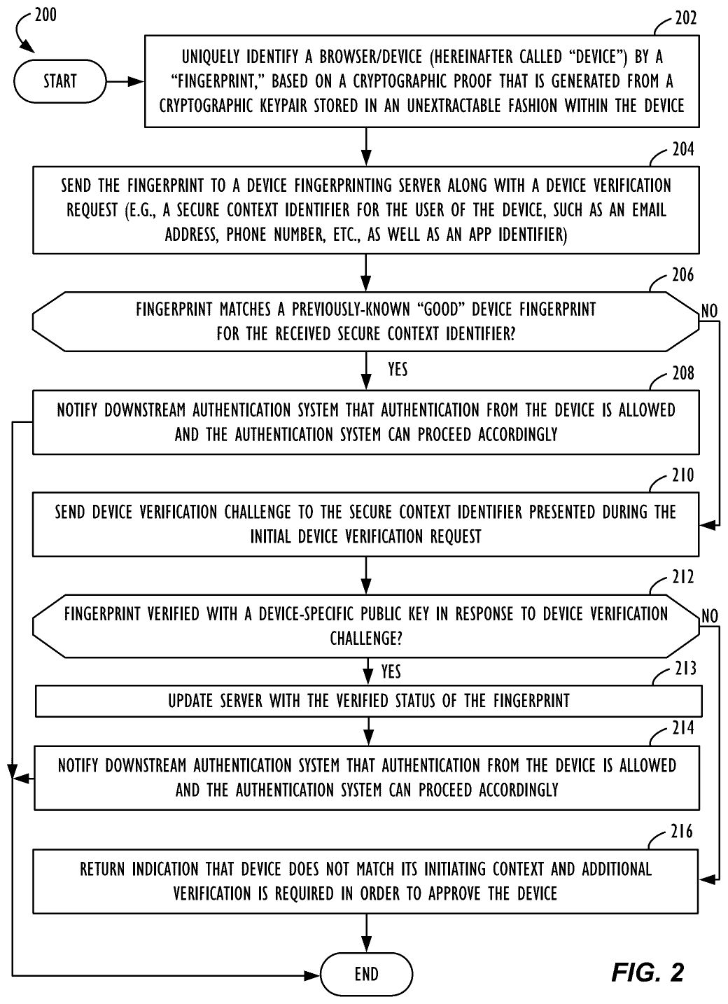

Turning now to FIG. 2, a flowchart for a method 200, is shown. First at block 202, the method 200 may begin by uniquely identifying a browser/device (hereinafter called “device” in the context of FIG. 2) by a fingerprint, e.g., based on a cryptographic proof that is generated from a cryptographic keypair stored in an unextractable fashion within the device. According to some embodiments, the webcrypto keypair may be used to create a Demonstrated Proof of Possession (DPoP) proof, which is then sent to a device profiler, e.g., on a verification server. The DPoP proof is preferably limited to a one-time use. According to some embodiments, the fingerprint is generated in an iframe or other secure environment of the initiating browser 103. In some embodiments, a device profile may be created for any verified device, which may be configured to store a list of all the browser application/device combinations that a user has ever logged in to the secure system with.

Next, at block 204, the method 200 may continue by sending the fingerprint to a device fingerprinting server along with a device verification request (e.g., a secure context identifier for the user of the device, such as an email address, phone number, etc., as well as an app identifier).

Next, at block 206, the method 200 may continue by determining whether the fingerprint matches a previously known “good” device fingerprint for the received secure context identifier. If the fingerprint is a match (i.e., “YES” at block 206), the method 200 may continue to block 208 to notify a downstream authentication system that the authentication from the device is allowed and that the authentication system can proceed accordingly, allowing method 200 to end.

If, instead, the fingerprint is not a match (i.e., “NO” at block 206), the method 200 may continue to block 210 to send a device verification challenge to the secure context identifier presented during the initial device verification request. Next, at block 212, the method 200 may continue by determining whether the fingerprint may be verified using a device-specific public key. If the fingerprint is verified (i.e., “YES” at block 212), the method 200 may continue to block 213, which updates the server with the verified status of the fingerprint and proceeds to block 214 to notify a downstream authentication system that the authentication from the device is allowed and that the authentication system can proceed accordingly, allowing method 200 to end.

If, instead, the fingerprint cannot be verified (i.e., “NO” at block 212), the method 200 may continue to block 216 to return an indication that the device does not match its initiating context and additional verification is required in order to approve the device. The additional verification required may be dependent on the needs and/or security level of a given system implementation.

For example, in an email login context, the additional verification step may include an email link that contains a signed token. The email link may redirect to the original requesting domain and verify that the webcrypto keypair stored in the browser is the same that signed the originating cryptographic signature, thus proving that the request came from the same browser/device where the email was originally opened. In the case of a cross-browser verification, i.e., where the keypair comparison results in a mismatch, the user can choose how to proceed, e.g., the user may be shown application-specified information about the originating request and permitted to manually approve or reject the login attempt, etc. In phone login contexts, the additional verification step may include an SMS message sent to the user with trusted information about the originating request and a prompt, e.g., to reply “1” to approve the login attempt or “2” to reject the login attempt, etc.

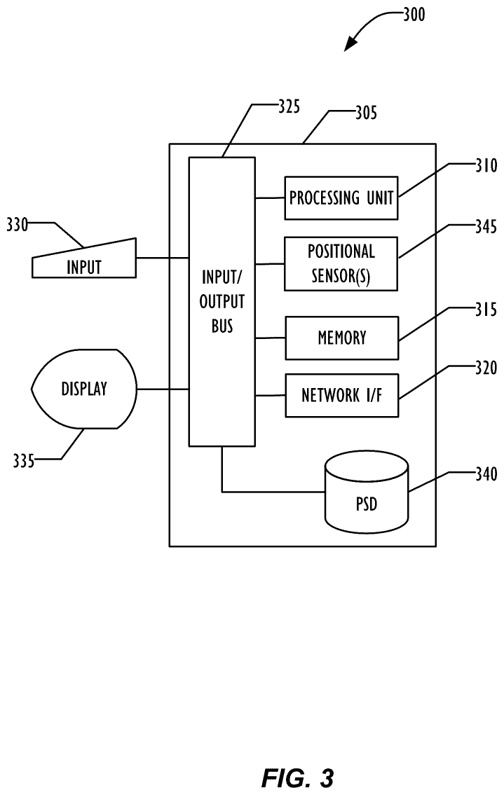

Referring now to FIG. 3, an example processing device 300 for use in the various operations described herein is illustrated in block diagram form, according to one or more disclosed embodiments. Processing device 300 may serve in, e.g., a mobile phone, end user computer, or a server computer. Example processing device 300 comprises a system unit 305 which may be optionally connected to an input device 330 (e.g., keyboard, mouse, touch screen, etc.) and display 335. A program storage device (PSD) 340 (sometimes referred to as a hard disk, flash memory, or non-transitory computer readable medium) is included with the system unit 305. Also included with system unit 305 may be a network interface 320 for communication via a network (either cellular or computer) with other mobile and/or embedded devices (not shown). Network interface 320 may be included within system unit 305 or be external to system unit 305. In either case, system unit 305 will be communicatively coupled to network interface 320. Program storage device 340 represents any form of non-volatile storage including, but not limited to, all forms of optical and magnetic memory, including solid-state storage elements, including removable media, and may be included within system unit 305 or be external to system unit 305. Program storage device 340 may be used for storage of software to control system unit 305, data for use by the processing device 300, or both.

System unit 305 may be programmed to perform methods in accordance with this disclosure. System unit 305 comprises one or more processing units, input-output (I/O) bus 325 and memory 315. Access to memory 315 can be accomplished using the communication bus 325. Processing unit 310 may include any programmable controller device including, for example, a mainframe processor, a mobile phone processor, or desktop class processor. Memory 315 may include one or more memory modules and comprise random access memory (RAM), read only memory (ROM), programmable read only memory (PROM), programmable read-write memory, and solid-state memory. As also shown in FIG. 3, system unit 305 may also include one or more positional sensors 345, which may comprise an accelerometer, gyroscope, global positioning system (GPS) device, or the like, and which may be used to track the movement of the device.

In the foregoing description, for purposes of explanation, numerous specific details are set forth in order to provide a thorough understanding of the disclosed embodiments. It will be apparent, however, to one skilled in the art that the disclosed embodiments may be practiced without these specific details. In other instances, structure and devices are shown in block diagram form in order to avoid obscuring the disclosed embodiments. References to numbers without subscripts or suffixes are understood to reference all instance of subscripts and suffixes corresponding to the referenced number. Moreover, the language used in this disclosure has been principally selected for readability and instructional purposes, and it may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one disclosed embodiment, and multiple references to “one embodiment” or “an embodiment” should not be understood as necessarily all referring to the same embodiment.

It is also to be understood that the above description is intended to be illustrative, and not restrictive. For example, above-described embodiments may be used in combination with each other, and illustrative process steps may be performed in an order different than shown. Many other embodiments will be apparent to those of skill in the art upon reviewing the above description. The scope of the invention therefore should be determined with reference to the appended claims, along with the full scope of equivalents to which such claims are entitled. In the appended claims, terms “including” and “in which” are used as plain-English equivalents of the respective terms “comprising” and “wherein.”

1. A method, comprising:
causing generation of a fingerprint for a device;
causing sending of the fingerprint, along with a device verification request, to a device fingerprinting server, wherein the device verification request comprises a secure context identifier for a user of the device;
in response to the device fingerprint server determining that the fingerprint matches a previously-known fingerprint for the secure context identifier:
causing receiving, at the device, of a notification that the device has been verified; and
in response to the device fingerprint server determining that the fingerprint does not match a previously-known fingerprint for the secure context identifier:
causing receiving, at the device, of a device verification challenge;
responding, at the device, to the device verification challenge; and
in response to the device fingerprint server verifying the fingerprint as part of the device verification challenge:
causing receiving, at the device, of a notification that the device has been verified.

2. The method of claim 1, wherein the fingerprint comprises a cryptographic proof that is generated from a cryptographic keypair.

3. The method of claim 2, wherein the cryptographic keypair is stored in an unextractable fashion in the device.

4. The method of claim 1, wherein the device further comprises a browser or mobile app executing on the device and configured to perform the device verification request and the device verification challenge.

5. The method of claim 1, wherein the response to the device verification challenge comprises an email challenge response.

6. The method of claim 1, wherein the fingerprint comprises an anonymous and unique cryptographic proof for the device.

7. The method of claim 1, wherein the secure context identifier comprises one of: an email address, a telephone number, or some other unique user identifier.

8. The method of claim 1, wherein the device verification request further comprises an app identifier.

9. The method of claim 1, wherein verifying the fingerprint as part of the device verification challenge further comprises: verifying the fingerprint based, at least in part, on a cryptographic public key.

10. The method of claim 1, wherein, in response to the device fingerprint server failing to verify the fingerprint as part of the device verification challenge, the method further comprises:
receiving, at the device, a notification that additional verification is required in order to verify the device.

11. A method, comprising:
receiving, at a device fingerprinting server, a fingerprint generated for a device and a device verification request, wherein the device verification request comprises a secure context identifier for a user of the device;
in response to the device fingerprint server determining that the fingerprint matches a previously-known fingerprint for the secure context identifier:
sending, to the device, a notification that the device has been verified; and
in response to the device fingerprint server determining that the fingerprint does not match a previously-known fingerprint for the secure context identifier:
sending, to the device, a device verification challenge;
receiving, from the device, a response to the device verification challenge; and
in response to the verifying the fingerprint at the device fingerprint server as part of the device verification challenge:
sending, to the device, a notification that the device has been verified.

12. The method of claim 11, wherein the fingerprint comprises a cryptographic proof that is generated from a cryptographic keypair.

13. The method of claim 12, wherein the cryptographic keypair is stored in an unextractable fashion in the device.

14. The method of claim 11, wherein the device further comprises a browser or mobile app executing on the device and configured to perform the device verification request and the device verification challenge.

15. The method of claim 11, wherein the response to the device verification challenge comprises an email challenge response.

16. The method of claim 11, wherein the fingerprint comprises an anonymous and unique cryptographic proof for the device.

17. The method of claim 11, wherein the secure context identifier comprises one of: an email address, telephone number, or some other unique identifier.

18. The method of claim 11, wherein the device verification request further comprises an app identifier.

19. The method of claim 11, wherein verifying the fingerprint as part of the device verification challenge further comprises: verifying the fingerprint based, at least in part, on a cryptographic public key.

20. The method of claim 11, wherein, in response to the device fingerprint server failing to verify the fingerprint as part of the device verification challenge, the method further comprises:
sending, to the device, a notification that additional verification is required in order to verify the device.
